(19) United States
(12) Patent Application Publication
(10) Pub. No.: US 2022/0065097 A1
(43) Pub. Date: Mar. 3, 2022

(54) METHOD FOR SELF-ADAPTIVE SURVEY CALCULATION OF WELLBORE TRAJECTORY

(71) Applicant: CHINA UNIVERSITY OF PETROLEUM (EAST CHINA), Qingdao (CN)

(72) Inventors: GENLU HUANG, QINGDAO (CN); FAN YU, QINGDAO (CN); WEI LI, QINGDAO (CN)

(21) Appl. No.: 17/522,791

(22) Filed: Nov. 9, 2021

Related U.S. Application Data
(63) Continuation of application No. PCT/CN2020/102782, filed on Jul. 17, 2020.

(30) Foreign Application Priority Data
Jul. 16, 2020 (CN) 202010684035.7

(51) Int. Cl. E21B 47/022; E21B 43/30; E21B 43/25

(52) U.S. Cl. CPC E21B 47/022; E21B 43/25; E21B 43/30

(57) ABSTRACT

The disclosure relates to a method for self-adaptive survey calculation of a wellbore trajectory in oil drilling, and belongs to the field of oil and gas drilling technologies. Curve characteristics of a calculated survey interval are identified by calculating measurement parameters of four survey stations corresponding to the survey interval and two survey intervals before and after the survey interval, so that an appropriate curve is selected to calculate a coordinate increment of the survey interval, then parameters of the curve characteristics which are close to the shape of the calculated wellbore trajectory are selected automatically, and the curve type which is closest to an actual wellbore trajectory is fitted automatically and the survey calculation is carried out.

### CROSS-REFERENCE TO RELATED APPLICATIONS

This application is a continuation of International Application No. PCT/CN2020/102782, filed on Jul. 17, 2020, which claims priority to Chinese Patent

Application No. 202010684035.7, filed on Jul. 16, 2020. The disclosures of the aforementioned applications are hereby incorporated by reference in their entireties.

### TECHNICAL FIELD

The present disclosure relates to the field of oil and gas drilling technologies, and in particular, to a method for self-adaptive survey calculation of a wellbore trajectory.

### BACKGROUND

Survey calculation of a wellbore trajectory in petroleum drilling usually requires a curve type of a survey interval between two survey stations to be assumed, then a coordinate increment of the survey interval is determined according to characteristics of this type of curve and wellbore direction constraints at two ends, and thus coordinates of respective survey stations of the wellbore trajectory are determined.

However, since it is unknown what type of curve an actual wellbore trajectory between two survey stations is, if all survey intervals of any trajectory are assumed to be one type of curve for performing survey calculation, it will inevitably lead to larger trajectory calculation errors when the assumed curve is inconsistent with an actual curve of a survey interval.

Regarding this problem, a latest method for survey calculation takes well inclination angles and azimuth angles of respective survey stations obtained by actual measurement as sample points and adopts cubic spline interpolation to obtain cubic spline interpolation functions of the well inclination angles and the azimuth angles of respective survey intervals, and obtains the wellbore trajectory by numerical integration. Theoretically, this processing method reduces calculation errors of the wellbore trajectory to a certain extent. However, cubic spline interpolation requires that the second derivative of interpolation function is continuous at sample points (survey stations), and in actual drilling, the first derivative and the second derivative of the well inclination angle and the azimuth angle may change significantly due to changes in drilling assembly, stratum, drilling mode (sliding drilling or rotary drilling) and drilling parameters, etc., which may lead to the oscillation of the interpolation function and produce errors far exceeding expectations. In addition, this method is also very sensitive to errors of the sample points, and the shorter a survey interval, the higher the sensitivity, and even unreasonable oscillation may occur.

### SUMMARY

The present disclosure provides a method for self-adaptive survey calculation of a wellbore trajectory, and aims to solve the problem of poor accuracy of survey calculation in the prior art. Curve characteristics of a calculated survey interval are identified by calculating measurement parameters of four survey stations corresponding to the survey interval and two survey intervals before and after the survey interval, so that an appropriate curve is selected to calculate a coordinate increment of the survey interval, which enables self-adaptive matching to curve characteristic parameters that are close to the shape of the wellbore trajectory of the survey interval to be calculated, and can significantly improve the accuracy of survey calculation of the wellbore trajectory.

A technical solution adopted by the present disclosure is as follows.

The present disclosure provides a method for self-adaptive survey calculation of a wellbore trajectory, including:

receiving survey data and processing the survey data, and numbering survey stations and survey intervals according to the survey data;

calculating, by using a conventional survey calculation method, a coordinate increment of a lower survey station relative to an upper survey station of a 1st survey interval;

calculating a coordinate increment of a lower survey station relative to an upper survey station of a 2nd survey interval according to the 1st survey interval, the 2nd survey interval and a 3rd survey interval, and calculating a coordinate increment of a lower survey station relative to an upper survey station of other survey interval by analogy, until a coordinate increment of a lower survey station relative to an upper survey station of a penultimate survey interval is calculated;

calculating, by using the conventional survey calculation method, a coordinate increment of a lower survey station relative to an upper survey station of a last survey interval;

calculating vertical depths, N coordinates, E coordinates, horizontal projection lengths, closure distances, closure azimuth angles and vertical sections in wellbore trajectory parameters of respective ones of the survey stations, according to coordinate increments of lower survey stations relative to upper survey stations of all the survey intervals.

Optionally, the coordinate increment includes a vertical depth increment, a horizontal projection length increment, an N coordinate increment and an E coordinate increment.

Optionally, the calculating a coordinate increment of a lower survey station relative to an upper survey station of a 2nd survey interval according to the 1st survey interval, the 2nd survey interval and a 3rd survey interval, specifically includes:

calculating estimated values of wellbore curvature, torsion and a tool face angle of the upper survey station of the 2nd survey interval according to well depths, well inclination angles and azimuth angles of three survey stations corresponding to the 1st survey interval and the 2nd survey interval;

calculating estimated values of wellbore curvature, torsion and a tool face angle of the lower survey station of the 2nd survey interval according to well depths, well inclination angles and azimuth angles of three survey stations corresponding to the 2nd survey interval and the 3rd survey interval;

calculating an estimated average change rate of wellbore curvature, an estimated average change rate of torsion, and an estimated tool face angle increment, between the upper survey station and the lower survey station of the 2nd survey interval;

determining a value range of wellbore curvature, a value range of torsion and a value range of tool face angle of the 2nd survey interval, by taking estimated wellbore curvature, estimated torsion and an estimated tool face angle of the upper survey station as reference values and taking ±10% of a wellbore curvature increment, ±10% of a torsion increment and ±10% of a tool face angle increment between the upper survey station and the lower survey station of the 2nd survey interval as fluctuation ranges;

determining, a value range of a change rate of the wellbore curvature and a value range of a change rate of the torsion of the 2nd survey interval, by taking the estimated average change rate of the wellbore curvature and the estimated average change rate of the torsion between the upper survey station and the lower survey station of the 2nd survey interval as reference values and fluctuating around the reference values up and down by 5%;

calculating the well inclination angle, the azimuth angle, the wellbore curvature and the torsion of the lower survey station of the 2nd survey interval, from the wellbore curvature, the torsion and the tool face angle of the upper survey station of the 2nd survey interval and the change rate of the wellbore curvature and the change rate of the torsion of the 2nd survey interval and within the determined value range of the change rate of the wellbore curvature and the determined value range of the change rate of the torsion of the 2nd survey interval;

calculating a comprehensive angular deviation between the calculated values and measured values of the well inclination angle and the azimuth angle at the lower survey station of the 2nd survey interval and a comprehensive deviation between the calculated values and estimated values of the curvature and the torsion at the upper survey station and the lower survey station of the 2nd survey interval; determining optimal values of the wellbore curvature, the torsion and the tool face angle of the upper survey station of the 2nd survey interval, and the change rate of the wellbore curvature and the change rate of the torsion of the 2nd survey interval, according to a principle of minimum comprehensive deviation of the curvature and the torsion of the upper survey station and the lower survey station of the 2nd survey interval on a premise that an angular deviation at the lower survey station of the 2nd survey interval is less than a specified value of 0.0002;

calculating the coordinate increment of the lower survey station relative to the upper survey station of the 2nd survey interval, according to the optimal values of the wellbore curvature, the torsion and the tool face angle of the upper survey station of the 2nd survey interval and the change rate of the wellbore curvature and the change rate of the torsion of the 2nd survey interval.

Optionally, the calculating, by using a conventional survey calculation method, a coordinate increment of a lower survey station relative to an upper survey station of a 1st survey interval, specifically includes:

calculating, according to a formula γ₀₁=arccos[cos α₀·cos α₁+sin α₀·sin α₁·cos(φ₁−φ₀)], a dogleg angle of the 1st survey interval, where γ₀₁ is the dogleg angle of the 1st survey interval; α₀ is a well inclination angle of a 0th survey station, α₁ is a well inclination angle of the 1st survey station, φ₀ is an azimuth angle of the 0th survey station, and φ₁ is an azimuth angle of the 1st survey station;

calculating, if the dogleg angle of the 1st survey interval is equal to zero, the coordinate increment of the lower survey station relative to the upper survey station of the 1st survey interval by using a following formula

$$\{ \begin{matrix}\begin{matrix}\begin{matrix}{Δ D}_{01} = ( {L}_{1} - {L}_{0} ) \cdot {cosα}_{0} \\ {Δ L}_{p 01} = ( {L}_{1} - {L}_{0} ) \cdot {sinα}_{0}\end{matrix} \\ {Δ N}_{01} = ( {L}_{1} - {L}_{0} ) \cdot {sinα}_{0} \cdot {cosφ}_{0}\end{matrix} \\ {Δ E}_{01} = ( {L}_{1} - {L}_{0} ) \cdot {sinα}_{0} \cdot {sinφ}_{0}\end{matrix} ,$$

where L₀ is a well depth of the 0th survey station; L₁ is a well depth of the 1st survey station, ΔD₀₁ is a vertical depth increment of the 1st survey interval, ΔLₚ₀₁ is a horizontal projection length increment of the 1st survey interval, ΔN₀₁ is an N coordinate increment of the 1st survey interval, and ΔE₀₁ is an E coordinate increment of the 1st survey interval;

calculating, if the dogleg angle of the 1st survey interval is greater than zero, the coordinate increment of the lower survey station relative to the upper survey station of the 1st survey interval by using a following formula

$$\{ \begin{matrix}\begin{matrix}\begin{matrix}{Δ D}_{01} = {R}_{01} \cdot tan ( {Y}_{01} / 2 ) \cdot ( {cosα}_{0} + {cosα}_{1} ) \\ {Δ L}_{p 01} = {R}_{01} \cdot tan ( {Y}_{01} / 2 ) \cdot ( {sinα}_{0} + {sinα}_{1} )\end{matrix} \\ {Δ N}_{01} = {R}_{01} \cdot tan ( {Y}_{01} / 2 ) \cdot ( {sinα}_{0} \cdot + {cosφ}_{0} + {sinα}_{1} \cdot {cosφ}_{1} )\end{matrix} \\ {Δ E}_{01} = {R}_{01} \cdot tan ( {Y}_{01} / 2 ) \cdot ( {sinα}_{0} \cdot {sinφ}_{0} + {sinα}_{1} \cdot {sinφ}_{1} )\end{matrix} ,$$

where ΔD₀₁ is the vertical depth increment of the 1st survey interval, ΔLₚ₀₁ is the horizontal projection length increment of the 1st survey interval, ΔN₀₁ is the N coordinate increment of the 1st survey interval, ΔE₀₁ is the E coordinate increment of the 1st survey interval, and R₀₁ is curvature radius of an arc of the 1st survey interval.

Optionally, the calculating, by using the conventional survey calculation method, a coordinate increment of a lower survey station relative to a previous survey station of a last survey interval, specifically includes:

calculating, according to a formula γ₍ₘ₋₁₎ₘ=arccos[cos αₘ₋₁cos αₘ+sin αₘ₋₁ sin αₘ cos(φₘ−φₘ₋₁)], a dogleg angle of the last survey interval, where γ₍ₘ₋₁₎ is a dogleg angle of an mth survey interval, αₘ is a well inclination angle of the mth survey station, φₘ is an azimuth angle of the mth survey station, αₘ₋₁ is a well inclination angle of an (m−1)th survey station and αₘ₋₁ is an azimuth angle of the (m−1)th survey station;

calculating, if the dogleg angle of the mth survey interval is equal to zero, the coordinate increment of the lower survey station relative to the upper survey station of the mth survey interval by using a following formula

$$\{ \begin{matrix}\begin{matrix}\begin{matrix}{Δ D}_{( m - 1 ) m} = ( {L}_{m} - {L}_{m - 1} ) \cdot {cosα}_{m} \\ {Δ L}_{p ( m - 1 ) m} = ( {L}_{m} - {L}_{m - 1} ) \cdot {sinα}_{m}\end{matrix} \\ {Δ N}_{( m - 1 ) m} = ( {L}_{m} - {L}_{m - 1} ) \cdot {sinα}_{m} \cdot {cosφ}_{m}\end{matrix} \\ {Δ E}_{( m - 1 ) m} = ( {L}_{m} - {L}_{m - 1} ) \cdot {sinα}_{m} \cdot {sinφ}_{m}\end{matrix} ,$$

where Lₘ is a well depth of the mth survey station, Lₘ₋₁ is a well depth of the (m−1)th survey station, ΔD₍ₘ₋₁₎ₘ is a vertical depth increment of the mth survey interval, ΔLₚ₍ₘ₋₁₎ₘ is a horizontal projection length increment of the mth survey interval, ΔN₍ₘ₋₁₎ₘ is an N coordinate increment of the mth survey interval, and ΔE₍ₘ₋₁₎ₘ is an E coordinate increment of the mth survey interval;

calculating, if the dogleg angle of the mth survey interval is greater than zero, the coordinate increment of the lower survey station relative to the upper survey station of the mth survey interval by using a following formula

$$\{ \begin{matrix}\begin{matrix}\begin{matrix}{Δ D}_{( m - 1 ) m} = {R}_{( m - 1 ) m} \cdot tan ( {Y}_{( m - 1 ) m} / 2 ) \cdot ( {cosα}_{m - 1} + {cosα}_{m} ) \\ {Δ L}_{p ( m - 1 ) m} = {R}_{( m - 1 ) m} \cdot tan ( {Y}_{( m - 1 ) m} / 2 ) \cdot ( {sinα}_{m - 1} + {sinα}_{m} )\end{matrix} \\ {Δ N}_{( m - 1 ) m} = {R}_{( m - 1 ) m} \cdot tan ( {Y}_{( m - 1 ) m} / 2 ) \cdot ( {sinα}_{m - 1} \cdot + {cosφ}_{m - 1} + {sinα}_{m} \cdot {cosφ}_{m} )\end{matrix} \\ {Δ E}_{( m - 1 ) m} = {R}_{( m - 1 ) m} \cdot tan ( {Y}_{( m - 1 ) m} / 2 ) \cdot ( {sinα}_{m - 1} \cdot {sinφ}_{m - 1} + {sinα}_{m} \cdot {sinφ}_{m} )\end{matrix} ,$$

where ΔD₍ₘ₋₁₎ₘ is the vertical depth increment of the mth survey interval, ΔLₚ₍ₘ₋₁₎ₘ is the horizontal projection length increment of the mth survey interval, ΔN₍ₘ₋₁₎ₘ is the N coordinate increment of the mth survey interval, ΔE₍ₘ₋₁₎ₘ is the E coordinate increment of the mth survey interval, and R₍ₘ₋₁₎ₘ is curvature radius of an arc of the mth survey interval.

Optionally, the calculating estimated values of wellbore curvature, torsion and a tool face angle of the upper survey station of the 2nd survey interval according to well depths, well inclination angles and azimuth angles of three survey stations corresponding to the 1st survey interval and the 2nd survey interval, specifically includes:

calculating, according to a formula k₁ₑ=\sqrt{k_{α1}²+k_{φ1}² sin α₁²}, the estimated value of the wellbore curvature of the upper survey station of the 2nd survey interval, where al is a well inclination angle of a 1st survey station, k₁ₑ is an estimated value of wellbore curvature at the 1st survey station, k_{α1} is a change rate of a well inclination angle at the 1st survey station, and k_{φ1} is a change rate of an azimuth angle at the 1st survey station; calculating, according to a formula

$${τ}_{1 e} = \frac{{k}_{01} {k}_{φ1} - {k}_{φ2} {k}_{a 1}}{{{k}_{1 e}}^{2}} {sinα}_{1} + {k}_{φ1} ( 1 + \frac{{{k}_{φ2}}^{2}}{{{k}_{1 e}}^{2}} ) {cos α}_{1} ,$$

the estimated value of the torsion of the upper survey station of the 2nd survey interval, where, α1 is the well inclination angle of the 1st survey station, k₁ₑ is the estimated value of the wellbore curvature at the 1st survey station, k_{α1} is the change rate of the well inclination angle at the 1st survey station, k_{φ1} is the change rate of the azimuth angle at the 1st survey station, \dot{k}_{α1} is a change rate of the change rate of the well inclination angle at the 1st survey station, \dot{k}_{φ1} is a change rate of the change rate of the azimuth angle at the 1st survey station, and τ₁ₑ is an estimated value of wellbore torsion at the 1st survey station;

calculating, according to a formula

$${ω}_{1 e} = \frac{1}{2} ⌈ \begin{matrix}sgn ( {Δφ}_{01} ) \cdot {cos}^{- 1} ( \frac{{cosα}_{0} - {cosα}_{1} {cosγ}_{01}}{{sinα}_{1} {sin γ}_{01}} ) \\ + sgn ( {Δφ}_{12} ) \cdot {cos}^{- 1} ( \frac{{cosα}_{1} - {cosγ}_{12} - {cosα}_{2}}{{sinα}_{1} {sin γ}_{12}} )\end{matrix} ⌉ ,$$

the estimated value of the tool face angle of the upper survey station of the 2nd survey interval, where, Φ₁ₑ is an estimated value of a tool face angle at the 1st survey station, Δφ₀₁ is an azimuth angle increment of the 1st survey interval, Δφ₁₂ is an azimuth angle increment of the 2nd survey interval, α₁ is the well inclination angle of the 1st survey station, α₀ is an well inclination angle of a 0th survey station, α₂ is the well inclination angle of the 2nd survey station, γ₀₁ is a dogleg angle of the 1st survey interval, and γ₁₂ is a dogleg angle of the 2nd survey interval.

Optionally, the calculating estimated values of wellbore curvature, torsion and a tool face angle of the lower survey station of the 2nd survey interval according to well depths, well inclination angles and azimuth angles of three survey stations corresponding to the 2nd survey interval and the 3rd survey interval, specifically includes:

calculating, according to a formula k₂ₑ=\sqrt{k_{α2}²+k_{φ2}² sin α₂²}, the estimated value of the wellbore curvature of the lower survey station of the 2nd survey interval where α2 is a well inclination angle of a 2nd survey station, k₂ₑ is an estimated value of wellbore curvature at the 2nd survey station, k_{α2} is a change rate of the well inclination angle at the 2nd survey station, and k_{φ2} is a change rate of an azimuth angle at the 2nd survey station;

calculating, according to a formula

$${τ}_{2 e} = \frac{{k}_{a 2} {k}_{p 2} - {k}_{φ2} {k}_{a 2}}{{{k}_{2 e}}^{2}} {sinα}_{2} + {k}_{φ2} ( 1 + \frac{{k}_{a 2}}{{{k}_{2 e}}^{2}} ) {cosα}_{2} ,$$

the estimated value of the torsion of the lower survey station of the 2nd survey interval, where α2 is the well inclination angle of the 2nd survey station, k₂ₑ is the estimated value of the wellbore curvature at the 2nd survey station, k_{α2} is the change rate of the well inclination angle at the 2nd survey station, k_{φ2} is the change rate of the azimuth angle at the 2nd survey station, \dot{k}_{α2} is a change rate of the change rate of the well inclination angle at the 2nd survey station, \dot{k}_{φ2} is a change rate of the change rate of the azimuth angle at the 2nd survey station, and τ_{φ2} is an estimated value of wellbore torsion at the 2nd survey station;

calculating, according to a formula

$${ω}_{1 e} = \frac{1}{2} ⌈ \begin{matrix}sgn ( {Δφ}_{01} ) \cdot {cos}^{- 1} ( \frac{{cosα}_{0} - {cosα}_{1} {cosγ}_{01}}{{sinα}_{1} {sin γ}_{01}} ) \\ + sgn ( {Δφ}_{12} ) \cdot {cos}^{- 1} ( \frac{{cosα}_{1} - {cosγ}_{12} - {cosα}_{2}}{{sinα}_{1} {sin γ}_{12}} )\end{matrix} ⌉ ,$$

the estimated value of the tool face angle of the lower measuring point of the 2nd survey interval, where ω₂ₑ is an estimated value of a tool face angle at the 2nd survey station, Δφ₁₂ is an azimuth angel increment of the 2nd survey interval, Δφ₂₃ is an azimuth angel increment of the 3rd survey interval, α₂ is a well inclination angle of the 2nd survey station, α₁ is a well inclination angle of the 1st survey station, α₃ is a well inclination angle of a 3rd survey station, γ₁₂ is a dogleg angle of the 2nd survey interval, γ₂₃ is a dogleg angle of the 3rd survey interval.

Optionally, the calculating an estimated average change rate of wellbore curvature, an estimated average change rate of torsion, and an estimated tool face angle increment, between an upper survey station and a lower survey station of a 2nd survey interval, specifically includes:

calculating, according to a formula

$${A}_{k 12} = \frac{{k}_{2 e} - {k}_{1 e}}{{L}_{2} - {L}_{1}} ,$$

the estimated average change rate of well bore curvature between the upper survey station and the lower survey station of the 2nd survey interval, where Aₖ₁₂ is an average change rate of wellbore curvature of the 2nd survey interval, L₁ is a well depth of a 1st survey station, L₂ is a well depth of a 2nd survey station, k₁ₑ is an estimated value of wellbore curvature at the 1st survey station, and k₂ₑ is an estimated value of wellbore curvature at the 2nd survey station;

calculating, according to a formula

$${A}_{τ 12} = \frac{{τ}_{2 e} - {τ}_{1 e}}{{L}_{2} - {L}_{1}} ,$$

the estimated average change rate of the torsion between the upper survey station and the lower survey station of the 2nd survey interval, where A_{τ12} is an average change rate of wellbore torsion of the 2nd survey interval, τ₁ₑ is an estimated value of wellbore torsion at the 1st survey station, and τ₂ₑ is an estimated value of wellbore torsion at the 2nd survey station;

calculating, according to a formula

$${Δω}_{12} = \{ \begin{matrix}\begin{matrix}( {ω}_{2 e} - {ω}_{1 e} + 2 π ) \\ ( {ω}_{2 e} - {ω}_{1 e} )\end{matrix} \\ ( {ω}_{2 e} - {ω}_{1 e} - 2 π )\end{matrix} \begin{matrix}\begin{matrix}( {ω}_{2 e} - {ω}_{1 e} < - π ) \\ ( - π \leq {ω}_{2 e} - {ω}_{1 e} \leq π )\end{matrix} \\ ( {ω}_{2 e} - {ω}_{1 e} > π )\end{matrix} ,$$

the estimated tool face angle increment between the upper survey station and the lower survey station of the 2nd survey interval, where Δω₁₂ is a tool face angle increment of the 2nd survey interval, ω₁ₑ is an estimated value of a tool face angle at the 1st survey station, and ω₂ₑ is an estimated value of a tool face angle at the 2nd survey station.

Compared with the prior art, the present disclosure has the following beneficial effects. The coordinate increment of the 1st survey interval is calculated according to the survey data of the 0th survey station and the 1st survey station of the wellbore trajectory by using a currently conventional method for survey calculation (minimum curvature method or curvature radius method), then assuming that the curvature and the torsion both change linearly from the 2nd survey interval to the penultimate survey interval, the curvature, the torsion and the tool face angle at the 1st survey station are first calculated from the survey data of the 0th survey station, the 1st survey station and the 2nd survey station, and the change rate of curvature and the change rate of torsion of the 2nd survey interval are determined by taking the well inclination angle and the azimuth angle at the 2nd survey station as constraints, and on this basis, the coordinate increment of the 2nd survey interval is obtained by numerical integration; similar steps are repeated until the coordinate increment of the penultimate survey interval is calculated; next, the coordinate increment of the last survey interval is calculated by using the currently conventional method for survey calculation; finally, all trajectory parameters at all survey stations can be calculated according to the full trajectory parameters at the 0th survey station and coordinate increments of respective survey intervals; then curve characteristics parameters that are close to the shape of the calculated wellbore trajectory are selected automatically according to the change rules of the well inclination angel and the azimuth angle of the calculated survey interval and the survey intervals before and after the calculated survey interval, and the curve type which is closest to the actual wellbore trajectory is fitted automatically and the survey calculation is carried out, and thus an error caused by the mismatch between the assumed curve type and the actual wellbore trajectory curve is avoided, the accuracy of the survey calculation of the wellbore trajectory is significantly improved, which has important significance in relief wells, interconnecting wells, parallel horizontal wells and avoidance of collisions between dense wellbores.

### BRIEF DESCRIPTION OF DRAWINGS

FIG. 1 is a schematic flow chart of a method for self-adaptive survey calculation of a wellbore trajectory according to an embodiment of the present disclosure.

### DESCRIPTION OF EMBODIMENTS

In order to make the object, technical solution and advantages of the present disclosure clearer, the embodiments of the present disclosure are further described in detail below.

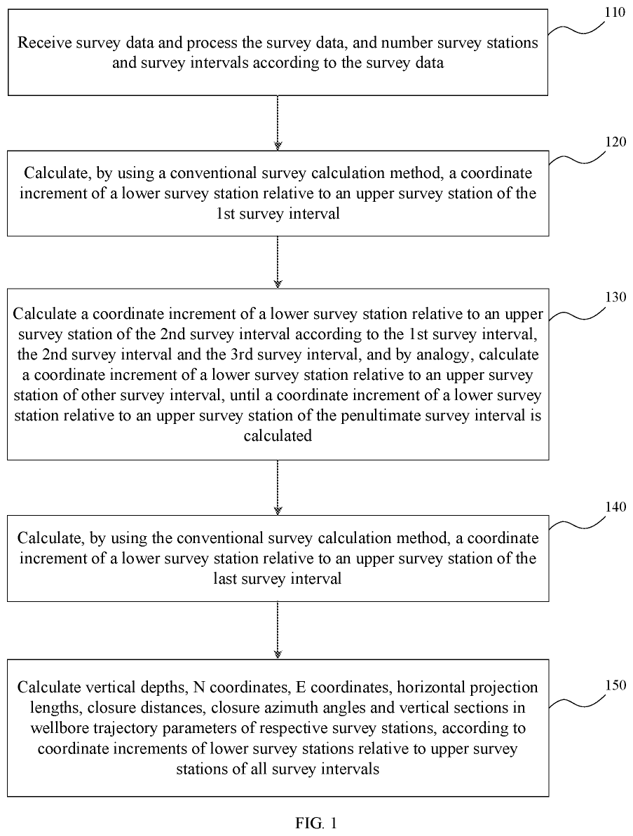

The method for self-adaptive survey calculation of a wellbore trajectory according to an embodiment of the present disclosure will be described in detail with reference to FIG. 1.

Referring to FIG. 1, an embodiment of the present disclosure provides a method for self-adaptive survey calculation of a wellbore trajectory.

Step 110: receive survey data and process the survey data, and number survey stations and survey intervals according to the survey data.

Specifically, a survey station which is the first one with a non-zero well inclination angle is the 1st survey station, and then the numbers of following survey stations are increased in turn until the last survey station. A position which is above the 1st survey station and the well depth of which is 25 m smaller than the depth of the 1st survey station is the 0th survey station. If the well depth of the 1st survey station is less than 25 m, the 0th survey station is a wellhead. In addition, a survey interval between the 0th survey station and the 1st survey station is a 1st survey interval, and by analogy, a survey interval between an (i−1)th survey station and an ith survey station is an ith survey interval, where i is a positive integer greater than or equal to 1.

For example, a survey station which is the first one with a non-zero well inclination angle is the 1st survey station, followed by the 2nd survey station, the 3rd survey station in turn, until the last survey station which is the mth survey station. The 0th survey station is at a position which is above the 1st survey station and which has a well depth 25 m smaller than the depth of the 1st survey station, and if the well depth of the 1st survey station is less than 25 m, the 0th survey station is a wellhead, i.e.

$${L}_{0} = \{ \begin{matrix}{L}_{1} - 25 \\ 0\end{matrix} \begin{matrix}( {L}_{1} > 25 m ) \\ ( {L}_{1} \leq 25 m )\end{matrix} , \qquad ( 1 )$$

where, L₀ is the well depth of the 0th survey station, m; L₁ is the well depth of the 1st survey station, m.

Other parameters of the 0th survey station are:

$$\{ \begin{matrix}\begin{matrix}\begin{matrix}\begin{matrix}\begin{matrix}\begin{matrix}\begin{matrix}{α}_{0} = 0 \\ {φ}_{0} = 0\end{matrix} \\ {D}_{0} = {L}_{0}\end{matrix} \\ {L}_{p 0} = 0\end{matrix} \\ {N}_{0} = 0\end{matrix} \\ {E}_{0} = 0\end{matrix} \\ {S}_{0} = 0\end{matrix} \\ {θ}_{0} = 0\end{matrix} , \qquad ( 2 )$$

where, αₒ is a well inclination angle of the 0th survey station, °; φ₀ is an azimuth angle of the 0th survey station, °; D₀ is a vertical depth of the 0th survey station, m; Lₚ₀ is a horizontal projection length of the 0th survey station, m; N₀ is an N coordinate of the 0th survey station, m; E₀ is an E coordinate of the 0th survey station, m; S₀ is a closure distance of the 0th survey station, m; θ₀ is a closure azimuth angle of the 0th survey station, °.

On the basis of the numbering of survey stations, a survey interval between the (i−1)th survey station and the ith survey station is the ith survey interval, and i can range from 1 to m.

Step 120: calculate, by using a conventional survey calculation method, a coordinate increment of a lower survey station relative to an upper survey station of the 1st survey interval;

where the coordinate increment includes a vertical depth increment, a horizontal projection length increment, an N coordinate increment and an E coordinate increment.

A dogleg angle of the 1st survey interval is calculated according to a formula γ₀₁=arccos[cos α₀·cos α₁+sin α₀·sin α₁·cos(φ₁−φ₀)] where γ₀₁ is the dogleg angle of the 1st survey interval, °; α₀ is the well inclination angle of the 0th survey station, °; α₁ is the well inclination angle of the 1st survey station, °; φ₀ is the azimuth angle of the 0th survey station, °; and φ₁ is an azimuth angle of the 1st survey station, °;

If the dogleg angle of the 1st survey interval is equal to zero, the coordinate increment of the lower survey station relative to the upper survey station of the 1st survey interval is calculated by using a following formula

$$\{ \begin{matrix}Δ {D}_{01} = ( {L}_{1} - {L}_{0} ) \cdot cos {α}_{0} \\ Δ {L}_{p 01} = ( {L}_{1} - {L}_{0} ) \cdot sin {α}_{0} \\ Δ {N}_{01} = ( {L}_{1} - {L}_{0} ) \cdot sin {α}_{0} \cdot cos {φ}_{0} \\ Δ {E}_{01} = ( {L}_{1} - {L}_{0} ) \cdot sin {α}_{0} \cdot sin {φ}_{0}\end{matrix} ,$$

where L₀ is a well depth of the 0th survey station, m; L₁ is the well depth of the 1st survey station, m; ΔD₀₁ is the vertical depth increment of the 1st survey interval, m; ΔLₚ₀₁ is the horizontal projection length increment of the 1st survey interval, m; ΔN₀₁ is the N coordinate increment of the 1st survey interval, m; and ΔE₀₁ is the E coordinate increment of the 1st survey interval, m.

If the dogleg angle of the 1st survey interval is greater than zero, the coordinate increment of the lower survey station relative to the upper survey station of the 1st survey interval is calculated by using a following formula

$$\{ \begin{matrix}Δ {D}_{01} = {R}_{01} \cdot tan ( {γ}_{01} / 2 ) \cdot ( cos {α}_{0} + cos {α}_{1} ) \\ Δ {L}_{p 01} = {R}_{01} \cdot tan ( {γ}_{01} / 2 ) \cdot ( sin {α}_{0} + sin {α}_{1} ) \\ Δ {N}_{ 01} = {R}_{01} \cdot tan ( {γ}_{01} / 2 ) \cdot ( sin {α}_{0} \cdot cos {φ}_{0} + sin {α}_{1} \cdot cos {φ}_{1} ) \\ Δ {N}_{ 01} = {R}_{01} \cdot tan ( {γ}_{01} / 2 ) \cdot ( sin {α}_{0} \cdot sin {φ}_{0} + sin {α}_{1} \cdot sin {φ}_{1} )\end{matrix} ,$$

where ΔD₀₁ is the vertical depth increment of the 1st survey interval, m; ΔLₚ₀₁ is the horizontal projection length increment of the 1st survey interval, m; ΔN₀₁ is the N coordinate increment of the 1st survey interval, m; ΔE₀₁ is the E coordinate increment of the 1st survey interval, m; and R₀₁ is curvature radius of an arc of the 1st survey interval, m.

γ₀₁=arccos[cos α₀ cos α₁+sin α₀·sin α₁·cos(φ₁−φ₀)] (3),

when γ₀₁=0:

$$\begin{matrix}\{ \begin{matrix}Δ {D}_{01} = ( {L}_{1} - {L}_{0} ) \cdot cos {α}_{0} \\ Δ {L}_{p 01} = ( {L}_{1} - {L}_{0} ) \cdot sin {α}_{0} \\ Δ {N}_{01} = ( {L}_{1} - {L}_{0} ) \cdot sin {α}_{0} \cdot cos {φ}_{0} \\ Δ {E}_{01} = ( {L}_{1} - {L}_{0} ) \cdot sin {α}_{0} \cdot sin {φ}_{0}\end{matrix} , & ( 4 ) \\ when {γ}_{01} > 0 \text{:} & \\ {R}_{01} - ( {L}_{1} - {L}_{0} ) - {γ}_{01} , & ( 5 ) \\ \{ \begin{matrix}Δ {D}_{01} = {R}_{01} \cdot tan ( {γ}_{01} / 2 ) \cdot ( cos {α}_{0} + cos {α}_{1} ) \\ Δ {L}_{p 01} = {R}_{01} \cdot tan ( {γ}_{01} / 2 ) \cdot ( sin {α}_{0} + sin {α}_{1} ) \\ Δ {N}_{ 01} = {R}_{01} \cdot tan ( {γ}_{01} / 2 ) \cdot ( sin {α}_{0} \cdot cos {φ}_{0} + sin {α}_{1} \cdot cos {φ}_{1} ) \\ Δ {E}_{ 01} = {R}_{01} \cdot tan ( {γ}_{01} / 2 ) \cdot ( sin {α}_{0} \cdot sin {φ}_{0} + sin {α}_{1} \cdot sin {φ}_{1} )\end{matrix} , & ( 6 )\end{matrix}$$

where, γ₀₁ is the dogleg angle of the 1st survey interval, °; α₁ is the well inclination angle of the 1st survey station, °; φ₁ is the azimuth angle of the 1st survey station, °; ΔD₀₁ is the vertical depth increment of the 1st survey interval, m; ΔLₚ₀₁ is the horizontal projection length increment of the 1st survey interval, m; ΔN₀₁ is the N coordinate increment of the 1st survey interval, m; ΔE₀₁ is the E coordinate increment of the 1st survey interval, m; and R₀₁ is the curvature radius of the arc of the 1st survey interval, m; other parameters are the same as before.

Step 130: calculate the coordinate increment of a lower survey station relative to an upper survey station of the 2nd survey interval according to the 1st survey interval, the 2nd survey interval and the 3rd survey interval, and by analogy, calculate a coordinate increment of a lower survey station relative to an upper survey station of other survey interval, until a coordinate increment of a lower survey station relative to an upper survey station of the penultimate survey interval is calculated.

Specifically, step 130 includes following sub-steps.

(1) Calculate estimated values of wellbore curvature, torsion and a tool face angle of the upper survey station of the 2nd survey interval according to well depths, well inclination angles and azimuth angles of three survey stations corresponding to the 1st survey interval and the 2nd survey interval.

The estimated value of the wellbore curvature of the upper survey station of the 2nd survey interval is calculated according to a formula k₁ₑ=\sqrt{k_{α1}²+k_{φ1}² sin α₁²}, where α1 is the well inclination angle of the 1st survey station, k₁ₑ is an estimated value of wellbore curvature at the 1st survey station, k_{α1} is a change rate of the well inclination angle at the 1st survey station, and k_{φ1} is an change rate of the azimuth angle at the 1st survey ₛₜₐₜᵢₒₙ;

The estimated value of the torsion of the upper survey station of the 2nd survey interval is calculated according to a formula

$${τ}_{1 e} = \frac{{k}_{α 1} {k}_{φ 1} - {k}_{φ 1} {k}_{α 1}}{{k}_{1 e}^{2}} sin {α}_{1} + {k}_{φ 1} ( 1 + \frac{{k}_{α 1}}{{k}_{1 e}^{2}} ) cos {α}_{1} ,$$

where α1 is the well inclination angle of the 1st survey station, k₁ₑ is the estimated value of the wellbore curvature at the 1st survey station, kₐ₁ is the change rate of the well inclination angle at the 1st survey station, k_{φ1} is the change rate of the azimuth angle at the 1st survey station, \dot{k}_{α1} is a change rate of the change rate of the well inclination angle at the 1st survey station, \dot{k}_{φ1} is a change rate of the change rate of the azimuth angle at the 1st survey station, and τ₁ₑ is an estimated value of wellbore torsion at the 1st survey station.

The estimated value of the tool face angle of the upper survey station of the 2nd survey interval is calculated according to a formula

$${ω}_{1 e} = \frac{1}{2} ⌈ \begin{matrix}sgn ( {Δφ}_{01} ) \cdot {cos}^{- 1} ( \frac{cos {α}_{0} - cos {α}_{1} cos {γ}_{01}}{sin {α}_{1} sin {γ}_{01}} ) \\ + sgn ( {Δφ}_{12} ) \cdot {cos}^{- 1} ( \frac{cos {α}_{1} - cos {γ}_{12} cos {α}_{2}}{sin {α}_{1} sin {γ}_{12}} )\end{matrix} ⌉ ,$$

where, ω₁ₑ is an estimated value of a tool face angle at the 1st survey station, Δφ₀₁ is an azimuth angle increment of the 1st survey interval, Δφ₁₂ is an azimuth angle increment of the 2nd survey interval, α₁ is the well inclination angle of the 1st survey station, α₀ is the well inclination angle of the 0th survey station, α₂ is a well inclination angle of the 2nd survey station, γ₀₁ is the dogleg angle of the 1st survey interval, γ₁₂ is a dogleg angle of the 2nd survey interval.

Specifically, the estimated values of the wellbore curvature, torsion and tool face angle of the upper survey station of the 2nd survey interval are calculated according to well depths, well inclination angles and azimuth angles of three survey stations corresponding to the 1st survey interval and the 2nd survey interval, by using following formulas.

$$\begin{matrix}{Δφ}_{01} = \{ \begin{matrix}( {φ}_{1} - {φ}_{0} + 2 π ) & ( {φ}_{1} - {φ}_{0} < - π ) \\ ( {φ}_{1} - {φ}_{0} ) & ( - π \leq {φ}_{1} - {φ}_{0} \leq π ) \\ ( {φ}_{1} - {φ}_{0} - 2 π ) & ( {φ}_{1} - {φ}_{0} > π )\end{matrix} , & ( 7 ) \\ {Δφ}_{12} = \{ \begin{matrix}( {φ}_{2} - {φ}_{1} + 2 π ) & ( {φ}_{2} - {φ}_{1} < - π ) \\ ( {φ}_{2} - {φ}_{1} ) & ( - π \leq {φ}_{2} - {φ}_{1} \leq π ) \\ ( {φ}_{2} - {φ}_{1} - 2 π ) & ( {φ}_{2} - {φ}_{1} > π )\end{matrix} , & ( 8 ) \\ {γ}_{01} = {cos}^{- 1} [ cos {α}_{0} cos {α}_{1} + sin {α}_{0} sin {α}_{1} cos ( {φ}_{1} - {φ}_{0} ) , & ( 9 ) \\ {γ}_{12} = {cos}^{- 1} [ cos {α}_{1} cos {α}_{2} + sin {α}_{1} sin {α}_{2} cos ( {φ}_{2} - {φ}_{1} ) , & ( 10 ) \\ {k}_{α 01} = \frac{{α}_{1} - {α}_{0}}{{L}_{1} - {L}_{0}} , & ( 11 ) \\ {k}_{φ 01} = \frac{{Δφ}_{01}}{{L}_{1} - {L}_{0}} , & ( 12 ) \\ {k}_{α 12} = \frac{{α}_{2} - {α}_{1}}{{L}_{2} - {L}_{1}} , & ( 13 ) \\ {k}_{φ 12} = \frac{{Δφ}_{12}}{{L}_{1} - {L}_{0}} , & ( 14 ) \\ {k}_{α1} = \frac{{k}_{α01} ( {L}_{2} - {L}_{1} ) + {k}_{α12} ( {L}_{1} - {L}_{0} )}{( {L}_{2} - {L}_{0} )} , & ( 15 ) \\ {k}_{φ 1} = \frac{{k}_{φ 01} ( {L}_{2} - {L}_{1} ) + {k}_{φ 12} ( {L}_{1} - {L}_{0} )}{( {L}_{2} - {L}_{0} )} , & ( 16 ) \\ {k}_{α1} = \frac{{k}_{α12} - {k}_{α01}}{( {L}_{2} - {L}_{0} ) / 2} , & ( 17 ) \\ {k}_{φ 1} = \frac{{k}_{φ 12} - {k}_{φ 01}}{( {L}_{2} - {L}_{0} ) / 2} , & ( 18 ) \\ {k}_{1 e} = \sqrt{{k}_{α i}^{2} + {k}_{φ i}^{2} sin {α}_{i}^{2}} , & ( 19 ) \\ {τ}_{1 e} = \frac{{k}_{α1} {k}_{φ 1} - {k}_{φ 1} {k}_{α 1}}{{k}_{1 e}^{2}} sin {α}_{1} + {k}_{φ 1} ( 1 + \frac{{k}_{α i}^{2}}{{k}_{1 e}^{2}} ) cos {α}_{1} , & ( 20 ) \\ {ω}_{1 e} = \frac{1}{2} ⌈ \begin{matrix}sgn ( {Δφ}_{01} ) \cdot {cos}^{- 1} ( \frac{cos {α}_{0} - cos {α}_{1} cos {γ}_{01}}{sin {α}_{1} sin {γ}_{01}} ) \\ + sgn ( {Δφ}_{12} ) \cdot {cos}^{- 1} ( \frac{cos {α}_{1} - cos {γ}_{12} cos {α}_{2}}{sin {α}_{1} sin {γ}_{12}} )\end{matrix} ⌉ , & ( 21 )\end{matrix}$$

where, Δφ₀₁ is the azimuth angle increment of the 1st survey interval, °; Δφ₁₂ is the azimuth angle increment of the 2nd survey interval, °; γ₁₂ is the dogleg angle of the 2nd survey interval, °; k_{α01} is an average change rate of the well inclination angle of the 1st survey interval, °/m; k_{φ01} is an average change rate of the azimuth angle of the 1st survey interval, °/m; k_{α12} is an average change rate of the well inclination angle of the 2nd survey interval, °/m; k_{φ12} is an average change rate of the azimuth angle of the 2nd survey interval, °/m; k_{α1} is the change rate of the well inclination angle at the 1st survey station, °/m; k_{φ1} is the change rate of the azimuth angle at the 1st survey station, °/m; k_{α1} is the change rate of the change rate of the well inclination angle at the 1st survey station, °/m²; \dot{k}_{φ1} is the change rate of the change rate of the azimuth angle at the 1st survey station, °/m²; k₁ₑ is the estimated value of the wellbore curvature at the 1st survey station, °/m; τ₁ₑ is the estimated value of the wellbore torsion at the 1st survey station, °/m; and ω₁ₑ is the estimated value of the tool face angle at the 1st survey station, °; other parameters are the same as before.

(2) Calculate estimated values of wellbore curvature, torsion and a tool face angle of the lower survey station of the 2nd survey interval according to well depths, well inclination angles and azimuth angles of three survey stations corresponding to the 2nd survey interval and the 3rd survey interval.

The estimated value of the wellbore curvature of the lower survey station of the 2nd survey interval is calculated according to a formula k₂ₑ=\sqrt{k_{α2}²+k_{φ2}² sin α₂²}, where α2 is the well inclination angle of the 2nd survey station, k₂ₑ is an estimated value of wellbore curvature at the 2nd survey station, k_{α2} is a change rate of the well inclination angle at the 2nd survey station, and k_{φ2} is a change rate of an azimuth angle at the 2nd survey station.

The estimated value of the torsion of the lower survey station of the 2nd survey interval is calculated according to a formula

$${τ}_{2 e} = \frac{{k}_{α 2} {k}_{φ 2} - {k}_{φ 2} {k}_{α 2}}{{k}_{2 e}^{2}} sin {α}_{2} + {k}_{φ 2} ( 1 + \frac{{k}_{α 2}^{2}}{{k}_{2 e}^{2}} ) cos {α}_{2} ,$$

where α2 is the well inclination angle of the 2nd survey station, k₂ₑ is the estimated value of the wellbore curvature at the 2nd survey station, k_{α2} is the change rate of the well inclination angle at the 2nd survey station, k_{φ2} is the change rate of the azimuth angle at the 2nd survey station, \dot{k}_{α2} is a change rate of the change rate of the well inclination angle at the 2nd survey station, \dot{k}_{φ2} is a change rate of the change rate of the azimuth angle at the 2nd survey station, and τ₂ₑ is an estimated value of wellbore torsion at the 2nd survey station.

The estimated value of the tool face angle of the lower survey station of the 2nd survey interval is calculated according to a formula

$${ω}_{2 e} = \frac{1}{2} ⌈ \begin{matrix}sgn ( {Δφ}_{12} ) \cdot {cos}^{- 1} ( \frac{cos {α}_{1} - cos {α}_{2} cos {γ}_{12}}{sin {α}_{1} sin {γ}_{01}} ) \\ + sgn ( {Δφ}_{23} ) \cdot {cos}^{- 1} ( \frac{cos {α}_{2} - cos {γ}_{23} cos {α}_{3}}{sin {α}_{2} sin {γ}_{23}} )\end{matrix} ⌉ ,$$

where ω₂ₑ is the estimated value of a tool face angle at the 2nd survey station, Δφ₁₂ is the azimuth angle increment of the 2nd survey interval, Δφ₂₃ is an azimuth increment of the 3rd survey interval, α₂ is a well inclination angle of the 2nd survey station, α₁ is the well inclination angle of the 1st survey station, α₃ is a well inclination angle of a 3rd survey station, γ₁₂ is a dogleg angle of the 2nd survey interval, γ₂₃ is a dogleg angle of the 3rd survey interval.

Specifically, the estimated values of the wellbore curvature, torsion and tool face angle of the lower survey station of the 2nd survey interval are calculated according to the well depths, well inclination angles and azimuth angles of the three survey stations corresponding to the 2nd survey interval and the third survey interval by using the following formulas.

$$\begin{matrix}{Δφ}_{23} = \{ \begin{matrix}( {φ}_{3} - {φ}_{2} + 2 π ) & ( {φ}_{3} - {φ}_{2} < - π ) \\ ( {φ}_{3} - {φ}_{2} ) & ( - π \leq {φ}_{3} - {φ}_{2} \leq π ) \\ ( {φ}_{3} - {φ}_{2} - 2 π ) & ( {φ}_{3} - {φ}_{2} > π )\end{matrix} , & ( 22 ) \\ {γ}_{23} = {cos}^{- 1} [ cos {α}_{2} cos {α}_{3} + sin {α}_{2} sin {α}_{3} cos ( {φ}_{3} - {φ}_{2} ) ] , & ( 23 ) \\ {k}_{23} = \frac{{α}_{3} - {α}_{2}}{{L}_{3} - {L}_{2}} , & ( 24 ) \\ {k}_{φ23} = \{ \begin{matrix}\frac{( {φ}_{3} - {φ}_{2} + 2 π )}{{L}_{3} - {L}_{2}} & ( {φ}_{3} - {φ}_{2} < - π ) \\ \frac{( {φ}_{3} - {φ}_{2} )}{{L}_{3} - {L}_{2}} & ( - π \leq {φ}_{3} - {φ}_{2} \leq π ) \\ \frac{( {φ}_{3} - {φ}_{2} - 2 π )}{{L}_{3} - {L}_{2}} & ( {φ}_{3} - {φ}_{2} > π )\end{matrix} , & ( 25 ) \\ {k}_{α 2} = \frac{{k}_{α 12} ( {L}_{3} - {L}_{2} ) + {k}_{α 23} ( {L}_{2} - {L}_{1} )}{{L}_{3} - {L}_{1}} , & ( 26 ) \\ {k}_{φ 2} = \frac{{k}_{φ 12} ( {L}_{3} - {L}_{2} ) + {k}_{φ 23} ( {L}_{2} - {L}_{1} )}{{L}_{3} - {L}_{1}} , & ( 27 ) \\ {\dot{k}}_{α 2} = \frac{{k}_{α 23} - {k}_{α 12}}{( {L}_{3} - {L}_{2} ) / 2} , & ( 28 ) \\ {\dot{k}}_{φ 2} = \frac{{k}_{φ 23} - {k}_{φ 12}}{( {L}_{3} - {L}_{1} ) / 2} , & ( 29 ) \\ {k}_{2 e} = \sqrt{{k}_{α 2}^{2} + {k}_{φ 2}^{2} sin {α}_{2}^{2}} , & ( 30 ) \\ {τ}_{2 e} = \frac{{k}_{α 2} {k}_{φ 2} - {k}_{φ 2} {k}_{α 2}}{{k}_{2 e}^{2}} sin {α}_{2} + {k}_{φ 2} ( 1 + \frac{{k}_{α 2}^{2}}{{k}_{2 e}^{2}} ) cos {α}_{2} , & ( 31 ) \\ {ω}_{2 e} = \frac{1}{2} ⌈ \begin{matrix}sgn ( {Δφ}_{12} ) \cdot {cos}^{- 1} ( \frac{cos {α}_{1} - cos {α}_{2} cos {γ}_{12}}{sin {α}_{1} sin {γ}_{01}} ) \\ + sgn ( {Δφ}_{23} ) \cdot {cos}^{- 1} ( \frac{cos {α}_{2} - cos {γ}_{23} cos {α}_{3}}{sin {α}_{2} sin {γ}_{23}} )\end{matrix} ⌉ , & ( 32 )\end{matrix}$$

where Δφ₂₃ is the azimuth angle increment of the 3rd survey interval, °; γ₂₃ is the dogleg angle of the 3rd survey interval, °; k_{α23} is an average change rate of the well inclination angle of the 3rd survey interval, °/m; k_{φ23} is an average change rate of the azimuth angle of the 3rd survey interval, °/m; k_{α2} is the change rate of the well inclination angle at the 2nd survey station, °/m; k_{φ2} is the change rate of the azimuth angle at the 2nd survey station, °/m; \dot{k}_{α2} is a change rate of the change rate of the well inclination angle at the 2nd survey station, °/m²; \dot{k}_{φ2} is a change rate of the change rate of the azimuth angle at the 2nd survey station, °/m²; k₂ₑ is the estimated value of the wellbore curvature at the 2nd survey station, °/m; τ₂ₑ is the estimated value of the wellbore torsion at the 2nd survey station, °/m; and ω₂ₑ is the estimated value of the tool face angle at the 2nd survey station, °; other parameters are the same as before.

(3) Calculate an estimated average change rate of wellbore curvature, an estimated average change rate of torsion, and an estimated tool face angle increment, between the upper survey station and the lower survey station of the 2nd survey interval.

An estimated average change rate of wellbore curvature between an upper survey station and a lower survey station of a 2nd survey interval is calculated according to a formula

$${A}_{k 12} = \frac{{k}_{2 e} - {k}_{1 e}}{( {L}_{2} - {L}_{1} )} ,$$

where Aₖ₁₂ is an average change rate of the wellbore curvature of the 2nd survey interval, L₁ is the well depth of the 1^{st} survey station, L₂ is a well depth of the 2nd survey station, k₁ₑ is the estimated value of the wellbore curvature at the 1st survey station, and k₂ₑ is the estimated value of the wellbore curvature at the 2nd survey station;

An estimated average change rate of torsion between the upper survey station and the lower survey station of the 2nd survey interval is calculated according to a formula

$${A}_{τ12} = \frac{{τ}_{2 e} - {τ}_{1 e}}{( {L}_{2} - {L}_{1} )} ,$$

where A_{τ12} is an average change rate of wellbore torsion of the 2nd survey interval, τ₁ₑ is the estimated value of the wellbore torsion at the 1st survey station, and τ₂ₑ is the estimated value of the wellbore torsion at the 2nd survey station;

An estimated tool face angle increment between the upper survey station and the lower survey station of the 2nd survey interval is calculated according to a formula

$${Δω}_{12} = \{ \begin{matrix}( {ω}_{2 e} - {ω}_{1 e} + 2 π ) & ( {ω}_{2 e} - {ω}_{1 e} < - π ) \\ ( {ω}_{2 e} - {ω}_{1 e} ) & ( - π \leq {ω}_{2 e} - {ω}_{1 e} \leq π ) \\ ( {ω}_{2 e} - {ω}_{1 e} - 2 π ) & ( {ω}_{2 e} - {ω}_{1 e} > - π )\end{matrix} ,$$

where Δω₁₂ is the tool face angle increment of the 2nd survey interval, ω₁ₑ is the estimated value of the tool face angle at the 1st survey station, and ω₂ₑ is the estimated value of the tool face angle at the 2nd survey station.

Specifically, the process of calculating the estimated average change rate of the wellbore curvature, the estimated average change rate of the torsion and the estimated tool face angle increment, between the upper survey station and the lower survey station of the 2nd survey interval is as follows:

$$\begin{matrix}{A}_{k 12} = \frac{{k}_{2 e} - {k}_{1 e}}{{L}_{2} - {L}_{1}} , & ( 33 ) \\ {A}_{τ 12} = \frac{{τ}_{2 e} - {τ}_{1 e}}{{L}_{2} - {L}_{1}} , & ( 34 ) \\ {Δω}_{12} = \{ \begin{matrix}( {ω}_{2 e} - {ω}_{1 e} + 2 π ) & ( {ω}_{2 e} - {ω}_{1 e} < - π ) \\ ( {ω}_{2 e} - {ω}_{1 e} ) & ( - π \leq {ω}_{2 e} - {ω}_{1 e} \leq π ) \\ ( {ω}_{2 e} - {ω}_{1 e} - 2 π ) & ( {ω}_{2 e} - {ω}_{1 e} > - π )\end{matrix} , & ( 35 )\end{matrix}$$

where Aₖ₁₂ is the average change rate of the wellbore curvature of the 2nd survey interval, °/m²; A_{τ12} is the average change rate of the wellbore torsion of the 2nd survey interval, °/m²; Δω₁₂ is the tool face angle increment of the 2nd survey interval, °; other parameters are the same as before.

(4) Determine a value range of the wellbore curvature, a value range of the torsion and a value range of the tool face angle of the 2nd survey interval, by taking the estimated wellbore curvature, the estimated torsion and the estimated tool face angle of the upper survey station as reference values and taking ±10% of the wellbore curvature increment, ±10% of the torsion increment and ±10% of the tool face angle increment between the upper survey station and the lower survey station of the 2nd survey interval as fluctuation ranges.

Specifically, the estimated values of the wellbore curvature, the torsion and the tool face angle of the upper survey station (the 1st survey station) of the 2nd survey interval are taken as references, and upper and lower limits fluctuate around the reference values up and down by 10% of the variation ranges of the corresponding estimated values of the survey interval, namely

k_{1 max}=k₁ₑ+Aₖ₁₂·(L₂−L₁)·10% (36),

k_{1 min}=k₁ₑ−Aₖ₁₂·(L₂−L₁)·10% (37),

τ_{1 max}=τ₁ₑ+A_{τ12}·(L₂−L₁)·10% (38)

τ_{1 min}=τ₁ₑ−A_{τ12}·(L₂−L₁)·10% (39),

ω_{1 max}=ω₁ₑ+Δω₁₂·10% (40)

ω_{1 min}=ω₁ₑ−Δω₁₂·10% (41),

where k_{1 max} is an upper limit of a search interval of wellbore curvature at the 1st survey station, °/m; k_{1 min} is a lower limit of the search interval of wellbore curvature at the 1st survey station, °/m; τ_{1 max} is an upper limit of a search interval of wellbore torsion at the 1st survey station, °/m; τ_{1 min} is a lower limit of the search interval of wellbore torsion at the 1st survey station, °/m; ω_{1 max} is an upper limit of a search interval of the tool face angle at the 1st survey station, °; ω_{1 min} is a lower limit of the search interval of the tool face angle at the 1st survey station, °; other parameters are the same as before.

(5) Determine a value range of the change rate of the wellbore curvature and a value range of the change rate of the torsion of the 2nd survey interval by taking the average change rate of the wellbore curvature and the average change rate of the torsion between the upper survey station and the lower survey station of the 2nd survey interval as the reference values, and fluctuating around the reference values up and down by 5%.

Specifically, the value range of the change rate of the wellbore curvature and the value range of the change rate of the torsion of the 2nd survey interval are determined according to the following formulas by taking the average change rate of the wellbore curvature and the average change rate of the torsion between the upper survey station and the lower survey station of the 2nd survey interval as the reference values and taking up and down fluctuations of 5% of the reference values.

A_{k max}=1.05·Aₖ₁₂ (42),

A_{k min}=0.95=Aₖ₁₂ (43),

A_{τ max}=1.05·A_{τ12} (44),

_{τ min}=0.95·A_{τ12} (45),

where A_{k max} is an upper limit of a search interval of the wellbore curvature change rate of the 2nd survey interval, °/m; A_{k min} is a lower limit of the search interval of the wellbore curvature change rate of the 2nd survey interval, °/m; A_{τ max} is an upper limit of a search interval of the change rate of the wellbore torsion of the 2nd survey interval, °/m; A_{τ min} is a lower limit of the search interval of the change rate of the wellbore torsion of the 2nd survey interval, °/m; other parameters are the same as before.

(6) Calculate the well inclination angle, the azimuth angle, the wellbore curvature and the torsion of the lower survey station of the 2nd survey interval, from the wellbore curvature, the torsion and the tool face angle of the upper survey station of the 2nd survey interval and the change rate of section curvature and the change rate of the torsion of the 2nd survey interval and within the determined range of the change rate of the wellbore curvature and the determined range of the change rate of the torsion of the 2nd survey interval.

Specifically, parameter such as the well inclination angle, the azimuth angle, the wellbore curvature, the torsion and the tool face angle of the lower survey station of the 2nd survey interval are calculated from the wellbore curvature, the torsion and the tool face angle of the upper survey station and the change rate of the wellbore curvature and the change rate of the torsion of the survey interval and within the determined range of the change rate of the wellbore curvature and the change rate of the torsion of the 2nd survey interval, by using following formulas. Specific calculation process is as follows:

\textcircled{1} Divide the survey interval into several segments n, where a segment length is ds;

\textcircled{2} Parameters at a starting point of a 1st segment s=0 are:

α(0)=α₁ (46),

φ(0)=φ₁ (47),

k(0)=k₁ₑ (48),

τ(0)=τ_{1c} (49),

ω(0)=ω_{1c} (50),

where k_{1c}, τ_{1c}, ω_{1c}, A_{kc} and A_{τc} are respectively certain values of the wellbore curvature, the wellbore torsion, the tool face angle of the upper survey station of the 2nd survey interval, and the change rate of the wellbore curvature and the change rate of wellbore torsion of the 2nd survey interval in their respective search intervals; α(0), φ(0), k(0), τ(0) and ω(0) are respectively a well inclination angle, an azimuth angle, wellbore curvature, wellbore torsion and a tool face angle at the well depth of s=0 from the upper survey station on the 2nd survey interval; and they are parameters corresponding to different depths when s takes different values.

\textcircled{3} Calculate parameters at s=(i+1) ds from parameters at s=i·ds,

α((i+1)·ds)=α(·ds)+k(i·ds)·cos ω(i·ds)·ds (51),

φ((i+1)·ds)=φ(i·ds)+k(i·ds)·sin ω(·ds)/sin α(i·ds)·ds (52),

k((i+1)·ds)=k(i·ds)+A_{kc}·ds (53),

τ((i+1) ds)=τ(i·ds)30 A_{τo}·ds (54),

ω((i+1)·ds)=ω(i·ds)+[τ(i·ds)−k(i·ds)·sin ω(i·ds)·sin ω(i·ds)/sin α(i·ds)·cos α(i·ds)]·ds (55),

(i=0, . . . , n−1).

\textcircled{4} Parameters at the lower survey station (the 2nd survey station) of the 2nd survey interval are parameters at the end point of the nth section s=n·ds,

α_{2c}=α(n·ds) (56),

α_{2c}=φ(n·ds) (57),

k_{2c}=k(n·ds) (58),

τ_{2c}=τ(n·ds) (59),

ω_{2c}=ω(n·ds) (60),

where α_{2c}, φ_{2c}, k_{2c}, τ_{2c} and ω_{2c} are respectively the well inclination angle, the azimuth angle, the wellbore curvature, the wellbore torsion and the tool face angle at the lower survey station calculated from the set of values (k_{1c}, τ_{1c}, ω_{1c}, A_{kc}, A_{τc}) at the upper survey station of the 2nd survey interval.

For example, the 2nd survey interval is divided into several segments first, initial values for iteration are determined according to the formulas (46)-(50) from the wellbore curvature, the torsion, the tool face angle of the upper survey station of the 2nd survey interval, and the change rate of the wellbore curvature and the change rate of the torsion of the 2nd survey interval; and parameters of the next point are calculated from parameters of the previous point according to iterative formats of the formulas (51)-(55) until the lower survey station of the 2nd survey interval; that is, the well inclination angle, the azimuth angle, the wellbore curvature and the torsion of the lower survey station can be calculated.

(7) Calculate a comprehensive angular deviation between the calculated values and measured values of the well inclination angle and the azimuth angle at the lower survey station of the 2nd survey interval and a comprehensive deviation between the calculated values and estimated values of the curvature and the torsion at the upper survey station and lower survey station of the 2nd survey interval; determine optimal values of the wellbore curvature, the torsion and the tool face angle of the upper survey station of the 2nd survey interval, and the change rate of the wellbore curvature and the change rate of the torsion of the 2nd survey interval according to a principle of minimum comprehensive deviation of the curvature and the torsion of the upper survey station and the lower survey station of the 2nd survey interval on the premise that an angular deviation at the lower survey station of the 2nd survey interval is less than a specified value of 0.0002.

Errors Δ₁ and Δ₂ for any group of values (k_{1c}, τ_{1c}, ω_{1c}, A_{kc}, A_{τc}) are calculated by using following formulas.

$$\begin{matrix}{Δ}_{1} = \sqrt{{( {α}_{2 c} - {α}_{2} )}^{2} + ( {φ}_{2 c} - {φ}_{2} ) sin {α}_{2}^{2}} , & ( 61 ) \\ {Δ}_{2} = \sqrt{{( {k}_{1 c} - {k}_{1 e} )}^{2} + {( {k}_{2 c} - {k}_{2 e} )}^{2} + {( {τ}_{1 c} - {τ}_{1 e} )}^{2} + {( {τ}_{2 c} - {τ}_{2 e} )}^{2}} . & ( 62 )\end{matrix}$$

(8) Calculate the coordinate increment of the lower survey station relative to the upper survey station of the 2nd survey interval, according to the optimal values of the wellbore curvature, the torsion and the tool face angle of the upper survey station of the 2nd survey interval and the change rate of the wellbore curvature and the change rate of the torsion of the 2nd survey interval.

Specifically, in given value ranges, a group of values (k_{1c}, τ_{1c}, ω_{1c}, A_{kc}, A_{τc}) satisfying Δ₁<0.0002 and having a minimum Δ₂ are determined as the optimal values (k₁ₒₚₜ, τ₁ₒₚₜ, ω₁ₒₚₜ, Aₖₒₚₜ, A_{τopt})

Then, the coordinate increment of the lower survey station relative to the upper survey station of the 2nd survey interval is calculated from the optimal values (k₁ₒₚₜ, τ₁ₒₚₜ, ω₁ₒₚₜ, Aₖₒₚₜ, A_{τopt}) of the upper survey station (the 1st survey station) of the 2nd survey interval. Specific calculation process is as follows:

\textcircled{1} Divide the survey interval into several segments n, where a segment length is ds;

\textcircled{2} Parameters at a starting point of a 1st segment s=0 are:

α(0)=α₁ (63),

φ(0)φ₁ (64),

k(0)=k₁ₒₚₜ (65),

τ(0)=τ₁ₒₚₜ (66),

ω(0)=ω₁ₒₚₜ (67).

\textcircled{3} Calculate parameters at s=(i+1)·ds from parameters at s=i·ds,

α((+ds)=α(i·ds)+k(i·ds)·cos ω(i·ds)·ds (68),

φ((i+1)·ds)=φ(i·ds)+k(i·ds)·sin ω(i·ds)/sin α(i·ds)·ds (69),

k((i+1)·ds)=k(i·ds)+Aₖₒₚₜ·ds (70),

τ((i+1)·ds)=τ(i·ds)+A_{τopt}·ds (71),

ω((+1)·ds)=ω(i·ds)+[τ(·ds)−k(·ds)·sin ω(i·ds)/sin α(si·ds)·cos α(i·ds)]·ds (72),

\textcircled{4} The coordinate increment of the lower survey station relative to the upper survey station of the 2nd survey interval

$$\{ \begin{matrix}Δ {D}_{12} = [ \frac{cos α ( 0 ) + cos α ( n \cdot d s )}{2} + {\sum }_{i = 1}^{n - 1} cos α ( i \cdot d s ) ] \cdot d s \\ Δ {L}_{12} = [ \frac{sin α ( 0 ) + sin α ( n \cdot d s )}{2} + {\sum }_{i = 1}^{n - 1} sin α ( i \cdot d s ) ] \cdot d s \\ Δ {N}_{12} = [ \begin{matrix}\frac{sin α ( 0 ) \cdot cos φ ( 0 ) + sin α ( n \cdot d s ) \cdot cos φ ( n \cdot d s )}{2} + \\ {\sum }_{i = 1}^{n - 1} sin α ( i \cdot d s ) \cdot sin φ ( i \cdot d s )\end{matrix} ] \cdot d s \\ Δ {E}_{12} = [ \begin{matrix}\frac{sin α ( 0 ) \cdot sin φ ( 0 ) + sin α ( n \cdot d s ) \cdot sin φ ( n \cdot d s )}{2} + \\ {\sum }_{i = 1}^{n - 1} sin α ( i \cdot d s ) \cdot sin φ ( i \cdot d s )\end{matrix} ] \cdot d s\end{matrix} ( i = 0 , … , n - 1 ) , \qquad ( 73 )$$

where ΔD₁₂ is the vertical depth increment of the 2nd survey interval, m; ΔLₚ₁₂ is the horizontal projection length increment of the 2nd survey interval, m; ΔN₁₂ is the N coordinate increment of the 2nd survey interval, m; ΔE₁₂ is the E coordinate increment of the 2nd survey interval, m; other parameters are the same as before.

For example, the 2nd survey interval is divided into several segments first, initial values for iteration are determined according to the formulas (63)-(67) from the optimal values of the wellbore curvature, the torsion, the tool face angle of the upper survey station of the 2nd survey interval, and the change rate of the wellbore curvature and the change rate of the torsion of the 2nd survey interval; and parameters of the next point are calculated from parameters of the previous point according to iterative formats of the formulas (68)-(72) until the lower survey station of the 2nd survey interval; finally, the coordinate increment of the lower survey station relative to the upper survey station of the 2nd survey interval is calculated according to the formula (73).

Step 140: calculate, by using the conventional survey calculation method, a coordinate increment of a lower survey station relative to an upper survey station of the last survey interval.

A dogleg angle of the last survey interval is calculated according to a formula γ₎ₘ₋₁₎ₘ=arccos[cos αₘ₋₁ cos αₘ+sin αₘ₋₁ sin αₘ₋₁ sin αₘ cos(φₘ−φₘ₋₁)], where γ₍ₘ₋₁₎ₘ is a dogleg angle of an mth survey interval, αₘ is a well inclination angle of the mth survey station, φₘ is an azimuth angle of the mth survey station, αₘ₋₁ is a well inclination angle of an (m−1)th survey station and φₘ₋₁ is an azimuth angle of the (m−1)th survey station;

If the dogleg angle of the mth survey interval is equal to zero, the coordinate increment of the lower survey station relative to the upper survey station of the mth survey interval is calculated by using following formulas

$$\{ \begin{matrix}Δ {D}_{( m - 1 ) m} = ( {L}_{m} - {L}_{m - 1} ) \cdot cos {α}_{m} \\ Δ {L}_{p ( m - 1 ) m} = ( {L}_{m} - {L}_{m - 1} ) \cdot sin {α}_{m} \\ Δ {N}_{( m - 1 ) m} = ( {L}_{m} - {L}_{m - 1} ) \cdot sin {α}_{m} \cdot cos {φ}_{m} \\ Δ {E}_{( m - 1 ) m} = ( {L}_{m} - {L}_{m - 1} ) \cdot sin {α}_{m} \cdot sin {φ}_{m}\end{matrix} ,$$

where Lₘ is a well depth of the mth survey station, m; Lₘ₋₁ is a well depth of the (m−1)th survey station, m; ΔD₍ₘ₋₁₎ₘ is a vertical depth increment of the mth survey interval, m; ΔLₚ₍ₘ₋₁₎ₘ is a horizontal projection length increment of the mth survey interval, m; ΔN₍ₘ₋₁₎ₘ is an N coordinate increment of the mth survey interval, m; and ΔE₍ₘ₋₁₎ₘ is an E coordinate increment of the mth survey interval, m.

If the dogleg angle of the mth survey interval is greater than zero, the coordinate increment of the lower survey station relative to the upper survey station of the m^{th} survey interval is calculated by using following formulas

$$\{ \begin{matrix}Δ {D}_{( m - 1 ) m} = {R}_{( m - 1 ) m} \cdot tan ( {γ}_{( m - 1 ) m} / 2 ) \cdot ( cos {α}_{m - 1} + cos {α}_{m} ) \\ Δ {L}_{p ( m - 1 ) m} = {R}_{( m - 1 ) m} \cdot tan ( {γ}_{( m - 1 ) m} / 2 ) \cdot ( sin {α}_{m - 1} + sin {α}_{m} ) \\ Δ {N}_{( m - 1 ) m} = {R}_{( m - 1 ) m} \cdot tan ( {γ}_{( m - 1 ) m} / 2 ) \cdot \\ ( sin {α}_{m - 1} \cdot cos {φ}_{m - 1} + sin {α}_{m} \cdot cos {φ}_{m} ) \\ \begin{matrix}Δ {E}_{( m - 1 ) m} = {R}_{( m - 1 ) m} \cdot tan ( {γ}_{( m - 1 ) m} / 2 ) \cdot \\ ( sin {α}_{m - 1} \cdot sin {φ}_{m - 1} + sin {α}_{m} \cdot sin {φ}_{m} )\end{matrix}\end{matrix} ,$$

where ΔD₍ₘ₋₁₎ₘ is the vertical depth increment of the mth survey interval, m; ΔLₚ₍ₘ₋₁₎ₘ is the horizontal projection length increment of the mth survey interval, m; ΔN₍ₘ₋₁₎ₘ is the N coordinate increment of the mth survey interval, m; ΔE₍ₘ₋₁₎ₘ is the E coordinate increment of the mth survey interval, m; and R₍ₘ₋₁₎ₘ is curvature radius of an arc of the mth survey interval, m.

For example, specific calculation formulas are as follows:

$$\begin{matrix}{γ}_{( m - 1 ) m} = arc cos [ cos {α}_{m - 1} cos {α}_{m} + sin {α}_{m - 1} sin {α}_{m} cos ( {φ}_{m} - {φ}_{m - 1} ) ] , & ( 74 ) \\ when {γ}_{( m - 1 ) m} = 0 : & \\ \{ \begin{matrix}Δ {D}_{( m - 1 ) m} = ( {L}_{m} - {L}_{m - 1} ) \cdot cos {α}_{m} \\ Δ {L}_{p ( m - 1 ) m} = ( {L}_{m} - {L}_{m - 1} ) \cdot sin {α}_{m} \\ Δ {N}_{( m - 1 ) m} = ( {L}_{m} - {L}_{m - 1} ) \cdot sin {α}_{m} \cdot cos {φ}_{m} \\ Δ {E}_{( m - 1 ) m} = ( {L}_{m} - {L}_{m - 1} ) \cdot sin {α}_{m} \cdot sin {φ}_{m}\end{matrix} , & ( 75 ) \\ when {γ}_{( m - 1 ) m} > 0 : & \\ {R}_{( m - 1 ) m} = ( {L}_{m} - {L}_{m - 1} ) / {γ}_{( m - 1 ) m} , & ( 76 ) \\ \{ \begin{matrix}Δ {D}_{( m - 1 ) m} = {R}_{( m - 1 ) m} \cdot tan ( {γ}_{( m - 1 ) m} / 2 ) \cdot ( cos {α}_{m - 1} + cos {α}_{m} ) \\ Δ {L}_{( m - 1 ) m} = {R}_{( m - 1 ) m} \cdot tan ( {γ}_{( m - 1 ) m} / 2 ) \cdot ( sin {α}_{m - 1} + sin {α}_{m} ) \\ Δ {N}_{( m - 1 ) m} = {R}_{( m - 1 ) m} \cdot tan ( {γ}_{( m - 1 ) m} / 2 ) \cdot \\ ( sin {α}_{m - 1} \cdot cos {φ}_{m - 1} + sin {α}_{m} \cdot cos {φ}_{m} ) \\ Δ {E}_{( m - 1 ) m} = {R}_{( m - 1 ) m} \cdot tan ( {γ}_{( m - 1 ) m} / 2 ) \cdot \\ ( sin {α}_{m - 1} \cdot sin {φ}_{m - 1} + sin {α}_{m} \cdot sin {φ}_{m} )\end{matrix} , & ( 77 )\end{matrix}$$

where γ₍ₘ₋₁₎ₘ is the dogleg angle of the mth survey interval, °; αₘ₋₁ is the well inclination angle of an (m−1)th survey station, °; φₘ₋₁ is an azimuth angle of the (m−1)th survey station, °; ΔD₍ₘ₋₁₎ₘ is the vertical depth increment of the mth survey interval, m; ΔLₚ₍ₘ₋₁₎ₘ is the horizontal projection length increment of the mth survey interval, m; ΔN₍ₘ₋₁₎ₘ is the N coordinate increment of the mth survey interval, m; ΔE₍ₘ₋₁₎ₘ is the E coordinate increment of the mth survey interval, m; R₍ₘ₋₁₎ₘ is curvature radius of the arc of the mth survey interval, m; other parameters are the same as before.

Step 150: calculate vertical depths, N coordinates, E coordinates, horizontal projection lengths, closure distances, closure azimuth angles and vertical sections in wellbore trajectory parameters of respective survey stations, according to coordinate increments of lower survey stations relative to upper survey stations of all survey intervals.

Specifically, the wellbore trajectory parameters such as the vertical depth, the horizontal projection length, the N coordinate, the E coordinate, the horizontal displacement, the translation azimuth angle and the vertical section of the lower survey station are calculated from the parameters of the upper survey station and the coordinate increment data of the survey interval.

$$\begin{matrix}{D}_{i} = {D}_{i - 1} + Δ {D}_{( i - 1 ) i} , & ( 78 ) \\ {L}_{pi} = {L}_{p ( i - 1 )} + Δ {L}_{p ( i - 1 ) i} , & ( 79 ) \\ {N}_{i} = {N}_{i - 1} + Δ {N}_{( i - 1 ) i} , & ( 80 ) \\ {E}_{i} = {E}_{i - 1} + Δ {E}_{( i - 1 ) i} , & ( 81 ) \\ {S}_{i} = \sqrt{{N}_{i}^{2} + {E}_{i}^{2}} , & ( 82 ) \\ {θ}_{i} = \{ \begin{matrix}arctan ( \frac{{E}_{i}}{{N}_{i}} ) & ( {N}_{i} > 0 ) \\ \frac{π}{2} & ( {N}_{i} = 0 , {E}_{i} \geq 0 ) \\ \frac{3 π}{2} & ( {N}_{i} = 0 , {E}_{j} < 0 ) \\ arctan ( \frac{{E}_{i}}{{N}_{i}} ) + π & ( {N}_{i} < 0 )\end{matrix} , & ( 83 ) \\ {V}_{i} = {S}_{i} \cdot cos ( {θ}_{i} - {θ}_{TB} ) , & ( 85 )\end{matrix}$$

where Dᵢ, Lₚᵢ, Nᵢ, Eᵢ, Sᵢ, θᵢ and Vᵢ are respectively a vertical depth, a horizontal projection length, an N coordinate, an E coordinate, a closure distance, a closure azimuth angle and a vertical section of an ith survey station; Dᵢ₋₁, Lₚ₍ᵢ₋₁₎, Nᵢ₋₁ and Eᵢ₋₁ are respectively a vertical depth, a horizontal projection length, an N coordinate and an E coordinate of an (i−1)th survey station; ΔD₍ᵢ₋₁₎ᵢ, ΔLₚ₍ᵢ₋₁₎ᵢ, ΔN₍ᵢ₋₁₎ᵢ and ΔE₍ᵢ₋₁₎ᵢ are respectively a vertical depth increment, a horizontal projection length increment, an N coordinate increment and an E coordinate increment of the ith survey interval; θ_{TB} is a design azimuth angle of the well.

In the method for self-adaptive survey calculation of a wellbore trajectory according to the embodiment of the disclosure, first, the coordinate increment of the 1st survey interval is calculated according to the survey data of the 0th survey station and the 1st survey station of the wellbore trajectory by using a currently conventional method for survey calculation (minimum curvature method or curvature radius method). Next, assuming that the curvature and the torsion both change linearly from the 2nd survey interval to the penultimate survey interval, and the curvature, the torsion and the tool face angle at the 1st survey station are first calculated from the survey data of the 0th survey station, the 1st survey station and the 2nd survey station, and the change rate of the curvature and the torsion of the 2nd survey interval are determined by taking the well inclination angle and azimuth angle at the 2nd survey station as constraints, and on this basis, the coordinate increment of the 2nd survey interval is obtained by numerical integration. Similar steps are performed until the coordinate increment of the penultimate survey interval is calculated. Then, the coordinate increment of the last survey interval is calculated by using the currently conventional method for survey calculation. Finally, all trajectory parameters at all survey stations can be calculated according to all trajectory parameters at the 0th survey station and coordinate increments of respective survey intervals. Then, the curve characteristics parameters which are closer to the shape of the calculated wellbore trajectory are selected automatically, and the curve type which is closest to an actual wellbore trajectory is fitted automatically and the survey calculation is carried out , and thus an error caused by the mismatch between the assumed curve type and the actual wellbore trajectory curve is avoided, the accuracy of the survey calculation of the wellbore trajectory is significantly improved, which has important significance in relief wells, interconnecting wells, parallel horizontal wells and avoidance of collisions between dense wellbores.

Obviously, those skilled in the art can make various modifications and variations to the embodiments of the present disclosure without departing from the spirit and scope of the embodiments of the present disclosure. In this way, if these modifications and variations of the embodiments of the present disclosure fall within the scope of the claims and their equivalent technologies, the present disclosure is also intended to include these modifications and variations.

What is claimed is:

1. A method for self-adaptive survey calculation of a wellbore trajectory, wherein the method for self-adaptive survey calculation of the wellbore trajectory comprises:
receiving survey data and processing the survey data, and numbering survey stations and survey intervals according to the survey data;
calculating, by using a conventional survey calculation method, a coordinate increment of a lower survey station relative to an upper survey station of a 1st survey interval;
calculating a coordinate increment of a lower survey station relative to an upper survey station of a 2nd survey interval according to the 1st survey interval, the 2nd survey interval and a 3rd survey interval, and calculating a coordinate increment of a lower survey station relative to an upper survey station of other survey interval by analogy, until a coordinate increment of a lower survey station relative to an upper survey station of a penultimate survey interval is calculated;
calculating, by using the conventional survey calculation method, a coordinate increment of a lower survey station relative to an upper survey station of a last survey interval;
calculating vertical depths, N coordinates, E coordinates, horizontal projection lengths, closure distances, closure azimuth angles and vertical sections in wellbore trajectory parameters of respective ones of the survey stations, according to coordinate increments of lower survey stations relative to upper survey stations of all the survey intervals;
wherein the calculating a coordinate increment of a lower survey station relative to an upper survey station of a 2nd survey interval according to the 1st survey interval, the 2nd survey interval and a 3rd survey interval, comprises:
calculating estimated values of wellbore curvature, torsion and a tool face angle of the upper survey station of the 2nd survey interval according to well depths, well inclination angles and azimuth angles of three survey stations corresponding to the 1st survey interval and the 2nd survey interval;
calculating estimated values of wellbore curvature, torsion and a tool face angle of the lower survey station of the 2nd survey interval according to well depths, well inclination angles and azimuth angles of three survey stations corresponding to the 2nd survey interval and the 3rd survey interval;
calculating an estimated average change rate of wellbore curvature, an estimated average change rate of torsion and an estimated tool face angle increment, between the upper survey station and the lower survey station of the 2nd survey interval;
determining a value range of wellbore curvature, a value range of torsion and a value range of tool face angle of the 2nd survey interval by taking the estimated values of the wellbore curvature, the torsion and the tool face angle of the upper survey station as reference values and taking ±10% of a wellbore curvature increment, ±10% of a torsion increment and ±10% of a tool face angle increment between the upper survey station and the lower survey station of the 2nd survey interval as fluctuation ranges;
determining a value range of a change rate of the wellbore curvature and a value range of a change rate of the torsion of the 2nd survey interval, by taking the estimated average change rate of the wellbore curvature and the estimated average change rate of the torsion between the upper survey station and the lower survey station of the 2nd survey interval as reference values and fluctuating around the reference values up and down by 5%;
calculating the well inclination angle, the azimuth angle, the wellbore curvature and the torsion of the lower survey station of the 2nd survey interval, from the wellbore curvature, the torsion and the tool face angle of the upper survey station of the 2nd survey interval and the change rate of the wellbore curvature and the change rate of the torsion of the 2nd survey interval and within the determined value range of the change rate of the wellbore curvature and the determined value range of the change rate of the torsion of the 2nd survey interval;
calculating a comprehensive angular deviation between the calculated values and measured values of the well inclination angle and the azimuth angle at the lower survey station of the 2nd survey interval and a comprehensive deviation between the calculated values and estimated values of the curvature and the torsion at the upper survey station and lower survey station of the 2nd survey interval; determining optimal values of the wellbore curvature, the torsion and the tool face angle of the upper survey station of the 2nd survey interval and the change rate of the wellbore curvature and the change rate of the torsion of the 2nd survey interval, according to a principle of minimum comprehensive deviation of the curvature and the torsion of the upper survey station and the lower survey station of the 2nd survey interval on a premise that an angular deviation at the lower survey station of the 2nd survey interval is less than a specified value of 0.0002;
calculating the coordinate increment of the lower survey station relative to the upper survey station of the 2nd survey interval, according to the optimal values of the wellbore curvature, the torsion and the tool face angle of the upper survey station of the 2nd and the change rate of the wellbore curvature and the change rate of the torsion of the 2nd survey interval.

2. The method for self-adaptive survey calculation of a wellbore trajectory according to claim 1, wherein the coordinate increment comprises a vertical depth increment, a horizontal projection length increment, an N coordinate increment and an E coordinate increment.

3. The method for self-adaptive survey calculation of a wellbore trajectory according to claim 2, wherein the calculating, by using a conventional survey calculation method, a coordinate increment of a lower survey station relative to a upper survey station of a 1st survey interval, comprises:
calculating, according to a formula γ₀₁=arccos[cos α₀·cos α₁+sin α₀·sin α₁ cos(φ₁−φ₀)], a dogleg angle of the 1st survey interval, wherein γ₀₁ is the dogleg angle of the 1st survey interval; α₀ is a well inclination angle of a 0th survey station, α₁ is a well inclination angle of the 1st survey station, α₀ is an azimuth angle of the 0th survey station, and α₁ is an azimuth angle of the 1st survey station;
calculating, if the dogleg angle of the 1st survey interval is equal to zero, the coordinate increment of the lower survey station relative to the upper survey station of the 1st survey interval by using a following formula
$$\{ \begin{matrix}Δ {D}_{01} = ( {L}_{1} - {L}_{0} ) \cdot cos {α}_{0} \\ Δ {L}_{p 01} = ( {L}_{1} - {L}_{0} ) \cdot sin α \\ Δ {N}_{01} = ( {L}_{1} - {L}_{0} ) \cdot sin {α}_{0} \cdot cos {φ}_{0} \\ Δ {E}_{01} = ( {L}_{1} - {L}_{0} ) \cdot sin {α}_{0} \cdot sin {φ}_{0}\end{matrix} ,$$
wherein L₀ is a well depth of the 0th survey station; L₁ is a well depth of the 1st survey station, ΔD₀₁ is a vertical depth increment of the 1st survey interval, ΔLₚ₀₁ is a horizontal projection length increment of the 1st survey interval, ΔN₀₁ is an N coordinate increment of the 1st survey interval, and ΔE₀₁ is an E coordinate increment of the 1st survey interval;
calculating, if the dogleg angle of the 1st survey interval is greater than zero, the coordinate increment of the lower survey station relative to the upper survey station of the 1st survey interval by using a following formula
$$\{ \begin{matrix}Δ {D}_{01} = {R}_{01} \cdot tan ( {γ}_{01} / 2 ) \cdot ( cos {α}_{0} + cos {α}_{1} ) \\ Δ {L}_{p 01} = {R}_{01} \cdot tan ( {γ}_{01} / 2 ) \cdot ( sin {α}_{0} + sin {α}_{1} ) \\ Δ {N}_{01} = {R}_{01} \cdot tan ( {γ}_{01} / 2 ) \cdot ( sin {α}_{0} \cdot cos {φ}_{0} + sin {α}_{1} \cdot cos {φ}_{1} ) \\ Δ {E}_{01} = {R}_{01} \cdot tan ( {γ}_{01} / 2 ) \cdot ( sin {α}_{0} \cdot sin {φ}_{0} + sin {α}_{1} \cdot sin {φ}_{1} )\end{matrix} ,$$
wherein ΔD₀₁ is the vertical depth increment of the 1st survey interval, ΔLₚ₀₁ is the horizontal projection length increment of the 1st survey interval, ΔN₀₁ is the N coordinate increment of the 1st survey interval, ΔE₀₁ is the E coordinate increment of the 1st survey interval, and R₀₁ is curvature radius of an arc of the 1st survey interval.

4. The method for self-adaptive survey calculation of a wellbore trajectory according to claim 2, wherein the calculating, by using the conventional survey calculation method, a coordinate increment of a lower survey station relative to a upper survey station of a last survey interval, comprises:
calculating, according to a formula γ₍ₘ₋₁₎ₘ=arccos[cos αₘ₋₁ cos αₘ+sin αₘ₋₁ sin αₘ cos(φₘ−φₘ₋₁)], a dogleg angle of the last survey interval, wherein γ₍ₘ₋₁₎ₘ is a dogleg angle of an mth survey interval, αₘ is a well inclination angle of the mth survey station, φₘ is an azimuth angle of the mth survey station, αₘ₋₁ is a well inclination angle of an (m−1)th survey station and φₘ₋₁ is an azimuth angle of the (m−1)th survey station;
calculating, if the dogleg angle of the mth survey interval is equal to zero, the coordinate increment of the lower survey station relative to the upper survey station of the mth survey interval by using a following formula
$$\{ \begin{matrix}Δ {D}_{( m - 1 ) m} = ( {L}_{m} - {L}_{m - 1} ) \cdot cos {α}_{m} \\ Δ {L}_{p ( m - 1 ) m} = ( {L}_{m} - {L}_{m - 1} ) \cdot sin {α}_{m} \\ Δ {N}_{( m - 1 ) m} = ( {L}_{m} - {L}_{m - 1} ) \cdot sin {α}_{m} \cdot cos {φ}_{m} \\ Δ {E}_{( m - 1 ) m} = ( {L}_{m} - {L}_{m - 1} ) \cdot sin {α}_{m} \cdot sin {φ}_{m}\end{matrix} ,$$
wherein Lₘ is a well depth of the mth survey station, Lₘ₋₁ is a well depth of the (m−1)th survey station, ΔD₍ₘ₋₁₎ₘ is a vertical depth increment of the mth survey interval, ΔLₚ₍ₘ₋₁₎ₘ is a horizontal projection length increment of the mth survey interval, ΔN₍ₘ₋₁₎ₘ is an N coordinate increment of the mth survey interval, and ΔE₍ₘ₋₁₎ₘ is an E coordinate increment of the mth survey interval;
calculating, if the dogleg angle of the mth survey interval is greater than zero, the coordinate increment of the lower survey station relative to the upper survey station of the mth survey interval by using a following formula
$$\{ \begin{matrix}Δ {D}_{( m - 1 ) m} = {R}_{( m - 1 ) m} \cdot tan ( {γ}_{( m - 1 ) m} / 2 ) \cdot ( cos {α}_{m - 1} + cos {α}_{m} ) \\ Δ {L}_{( m - 1 ) m} = {R}_{( m - 1 ) m} \cdot tan ( {γ}_{( m - 1 ) m} / 2 ) \cdot ( sin {α}_{m - 1} + sin {α}_{m} ) \\ Δ {N}_{( m - 1 ) m} = {R}_{( m - 1 ) m} \cdot tan ( {γ}_{( m - 1 ) m} / 2 ) \cdot ( sin {α}_{m - 1} \cdot cos {φ}_{m - 1} + sin {α}_{m} \cdot cos {φ}_{m} ) \\ Δ {E}_{( m - 1 ) m} = {R}_{( m - 1 ) m} \cdot tan ( {γ}_{( m - 1 ) m} / 2 ) \cdot ( sin {α}_{m - 1} \cdot sin {φ}_{m - 1} + sin {α}_{m} \cdot sin {φ}_{m} )\end{matrix} ,$$
wherein ΔD₍ₘ₋₁₎ₘ is the vertical depth increment of the mth survey interval, ΔLₚ₍ₘ₋₁₎ₘ is the horizontal projection length increment of the mth survey interval, ΔN₍ₘ₋₁₎ₘ is the N coordinate increment of the mth survey interval, ΔE₍ₘ₋₁₎ₘ is the E coordinate increment of the mth survey interval, and R₍ₘ₋₁₎ₘ is curvature radius of an arc of the mth survey interval.

5. The method for self-adaptive survey calculation of a wellbore trajectory according to claim 3, wherein the calculating estimated values of wellbore curvature, torsion and a tool face angle of the upper survey station of the 2nd survey interval according to well depths, well inclination angles and azimuth angles of three survey stations corresponding to the 1st survey interval and the 2nd survey interval, comprises:
calculating, according to a formula k₁ₑ=\sqrt{k_{α1}²+k_{φ1}² sin α₁²}, the estimated value of the wellbore curvature of the upper survey station of the 2nd survey interval, wherein α1 is a well inclination angle of a 1st survey station, k₁ₑ is an estimated value of wellbore curvature at the 1st survey station, k_{α1} is a change rate of a well inclination angle at the 1st survey station, and k_{φ1} is a change rate of an azimuth angle at the 1st survey station;
calculating, according to a formula
$${τ}_{1 e} = \frac{{k}_{α1} {k}_{φ 1} - {k}_{φ 1} {k}_{α 1}}{{k}_{1 e}^{2}} sin {α}_{1} + {k}_{φ1} ( 1 + \frac{{k}_{α 1}^{2}}{{k}_{1 e}^{2}} ) cos {α}_{1} ,$$
the estimated value of the torsion of the upper survey station of the 2nd survey interval, wherein α1 is the well inclination angle of the 1st survey station, k₁ₑ is the estimated value of the wellbore curvature at the 1st survey station, k_{α1} is the change rate of the well inclination angle at the 1st survey station, k_{φ1} is the change rate of the azimuth angle at the 1st survey station, \dot{k}_{α1} is the change rate of the well inclination angle at the 1st survey station, \dot{k}_{φ1} is a change rate of the change rate of the azimuth angle at the 1st survey station, and τ₁ₑ is an estimated value of torsion at the 1st survey station;
calculating, according to a formula
$${ω}_{1 e} = \frac{1}{2} ⌈ \begin{matrix}sgn ( Δ {φ}_{01} ) \cdot {cos}^{- 1} ( \frac{cos {α}_{0} - cos {α}_{1} cos {γ}_{01}}{sin {α}_{1} sin {γ}_{01}} ) + \\ sgn ( Δ {φ}_{12} ) \cdot {cos}^{- 1} ( \frac{cos {α}_{2} - cos {γ}_{12} cos {α}_{2}}{sin {α}_{1} sin {γ}_{12}} )\end{matrix} ⌉ ,$$
the estimated value of the tool face angle of the upper survey station of the 2nd survey interval, wherein ω₁ₑ is an estimated value of a tool face angle at the 1st survey station, Δφ₀₁ is an azimuth angle increment of the 1st survey interval, Δφ₁₂ is an azimuth angle increment of the 2nd survey interval, α₁ is the well inclination angle of the 1st survey station, α₀ is an well inclination angle of a 0th survey station, α₂ is the well inclination angle of the 2nd survey station, γ₀₁ is a dogleg angle of the 1st survey interval, γ₁₂ is a dogleg angle of the 2nd survey interval.

6. The method for self-adaptive survey calculation of a wellbore trajectory according to claim 3, wherein the calculating estimated values of wellbore curvature, torsion and a tool face angle of the lower survey station of the 2nd survey interval according to well depths, well inclination angles and azimuth angles of three survey stations corresponding to the 2nd survey interval and the 3rd survey interval, comprises:
calculating, according to a formula k₂ₑ=\sqrt{k_{α2}²+k_{φ2}² sin α₂²}, the estimated value of the wellbore curvature of the lower survey station of the 2nd survey interval, wherein α2 is a well inclination angle of a 2nd survey station, k₂ₑ is an estimated value of wellbore curvature at the 2nd survey station, k_{α2} is a change rate of the well inclination angle at the 2nd survey station, and k_{φ2} is a change rate of an azimuth angle at the 2nd survey station;
calculating, according to a formula
$${τ}_{2 e} = \frac{{k}_{α 2} {k}_{φ 2} - {k}_{φ 2} {k}_{α 2}}{{k}_{2 e}^{2}} sin {α}_{2} + {k}_{φ2} ( 1 + \frac{{k}_{α 2}^{2}}{{k}_{2 e}^{2}} ) cos {α}_{2} ,$$
the estimated value of the torsion of the lower survey station of the 2nd survey interval, wherein α2 is the well inclination angle of the 2nd survey station, k₂ₑ is the estimated value of the wellbore curvature at the 2nd survey station, k_{α2} is the change rate of the well inclination angle at the 2nd survey station, k_{φ2} is the change rate of the azimuth angle at the 2nd survey station, \dot{k}_{α2} is a change rate of the change rate of well inclination angle at the 2nd survey station, \dot{k}_{φ2} is a change rate of the change rate of azimuth angle at the 2nd survey station, and τ₂ₑ is an estimated value of torsion at the 2nd survey station;
calculating, according to a formula
$${ω}_{2 e} = \frac{1}{2} ⌈ \begin{matrix}sgn ( Δ {φ}_{12} ) \cdot {cos}^{- 1} ( \frac{cos {α}_{1} - cos {α}_{2} cos {γ}_{12}}{sin {α}_{2} sin {γ}_{12}} ) + \\ sgn ( Δ {φ}_{23} ) \cdot {cos}^{- 1} ( \frac{cos {α}_{2} - cos {γ}_{23} cos {γα}_{3}}{sin {α}_{2} sin {γ}_{23}} )\end{matrix} ⌉ ,$$
the estimated value of the tool face angle of the lower survey station of the 2nd survey interval, wherein ω₂ₑ is an estimated value of a tool face angle at the 2nd survey station, Δφ₁₂ is an azimuth angle increment of the 2nd survey interval, Δφ₂₃ is an azimuth angel increment of the 3rd survey interval, α₁ is a well inclination angle of the 1st survey station, α₂ is a well inclination angle of the 2nd survey station, α₃ is a well inclination angle of a 3rd survey station, γ₁₂ is a dogleg angle of the 2nd survey interval, and γ₂₃ is a dogleg angle of the 3rd survey interval.

7. The method for self-adaptive survey calculation of a wellbore trajectory according to claim 3, wherein the calculating an estimated average change rate of wellbore curvature, an estimated average change rate of torsion and an estimated tool face angle increment, between an upper survey station and a lower survey station of a 2nd survey interval, comprises:
calculating, according to a formula
$${A}_{k 12} = \frac{{k}_{2 e} - {k}_{1 e}}{{L}_{2} - {L}_{1}} ,$$
the estimated average change rate of wellbore curvature between the upper survey station and the lower survey station of the 2nd survey interval, wherein Aₖ₁₂ is an average change rate of wellbore curvature of the 2nd survey interval, L₁ is a well depth of a 1st survey station, L₂ is a well depth of a 2nd survey station, k₁ₑ is an estimated value of wellbore curvature at the 1st survey station, and k₂ₑ is an estimated value of wellbore curvature at the 2nd survey station;
calculating, according to a formula
$${A}_{τ12} = \frac{{τ}_{2 e} - {τ}_{1 e}}{{L}_{2} - {L}_{1}} ,$$
the estimated average change rate of the torsion between the upper survey station and the lower survey station of the 2nd survey interval, wherein A_{τ12} is an average change rate of torsion of the 2nd survey interval, τ₁ₑ is an estimated value of torsion at the 1st survey station, and τ₂ₑ is an estimated value of torsion at the 2nd survey station;
calculating, according to a formula
$${Δω}_{12} = \{ \begin{matrix}( {ω}_{2 e} - {ω}_{1 e} + 2 π ) & ( {ω}_{2 e} - {ω}_{1 e} < - π ) \\ ( {ω}_{2 e} - {ω}_{1 e} ) & ( - π \leq {ω}_{2 e} - {ω}_{1 e} \leq π ) \\ ( {ω}_{2 e} - {ω}_{1 e} - 2 π ) & ( {ω}_{2 e} - {ω}_{1 e} > π )\end{matrix} ,$$
the estimated tool face angle increment between the upper survey station and the lower survey station of the 2nd survey interval, wherein Δω₁₂ is a tool face angle increment of the 2nd survey interval, ω₁ₑ is an estimated value of a tool face angle at the 1st survey station, and ω₂ₑ is an estimated value of a tool face angle at the 2nd survey station.
